(19) United States
(12) Patent Application Publication
(10) Pub. No.: US 2026/0352656 A1
(43) Pub. Date: Nov. 5, 2026

(54) FACE AUTHENTICATION METHODS AND APPARATUSES

(71) Applicant: Alipay (Hangzhou) Digital Service Technology Co., Ltd., Hangzhou, Zhejiang (CN)

(72) Inventors: Wanqiao ZHANG, Hangzhou (CN); Lin HUANG, Hangzhou (CN); Shuaike DONG, Hangzhou (CN); Shangcheng SHI, Hangzhou (CN)

(21) Appl. No.: 19/487,000

(22) PCT Filed: Apr. 2, 2024
(86) PCT No.: PCT/CN2024/085640

§ 371 Date: Nov. 24, 2025

(30) Foreign Application Priority Data
May 26, 2023 (CN) 202310615866.2

(51) Int. Cl. H04L 9/40; G06V 40/16

(52) U.S. Cl. CPC H04L 63/0861; G06V 40/172

(57) ABSTRACT

Embodiments of this specification provide face authentication methods and apparatuses. The face authentication method performed in a verification server includes: receiving a face authentication request sent by a face verification APP in a terminal device, where the face authentication request carries face information; performing authentication on the face information to obtain a face authentication result; generating an authorization code; storing a first correspondence between the authorization code and the face authentication result; delivering the generated authorization code to the face verification APP, so that the face verification APP sends the authorization code to a third-party APP; receiving an authentication result query request sent by a third-party server; and determining whether the authentication result query request carries the authorization code, and if yes, sending the face authentication result corresponding to the authorization code carried in the authentication result query request to the third-party server.

### TECHNICAL FIELD

One or more embodiments of this specification relate to network information technologies, and in particular, to face authentication methods and apparatuses.

### BACKGROUND

With development of network technologies, an application scenario of a face authentication service is more extensive. For example, when payment is performed during shopping, face authentication is used to perform the payment. For another example, when a system is logged into or an access control is passed through, face authentication is used to perform an admission operation. In addition, currently, in addition to a small program and a third-party APP (application), some H5 pages also start to integrate face authentication. Therefore, security of the face authentication service is extremely important. However, current security of the face authentication service needs to be improved.

Therefore, a more secure face authentication method is urgently needed.

### SUMMARY

One or more embodiments of this specification describe face authentication methods and apparatuses, which can improve security of a face authentication service.

According to a first aspect, a face authentication method is provided. The method includes: receiving a face authentication request sent by a face verification APP in a terminal device, where the face authentication request carries face information; performing authentication on the face information to obtain a face authentication result; generating an authorization code; storing a first correspondence between the authorization code and the face authentication result; delivering the generated authorization code to the face verification APP, so that the face verification APP sends the authorization code to a third-party APP; receiving an authentication result query request sent by a third-party server; and determining whether the authentication result query request carries the authorization code, and if yes, sending the face authentication result corresponding to the authorization code carried in the authentication result query request to the third-party server, so that the third-party server sends the face authentication result to the third-party APP.

In the first aspect, before receiving the face authentication request sent by the face verification APP in the terminal device, the method further includes: receiving an authentication authorization request sent by the third-party server; obtaining an authentication identifier CertifyID based on user identity information carried in the authentication authorization request; and sending the CertifyID to the third-party server. After generating an authorization code, the method further includes: storing a second correspondence between the generated authorization code and the obtained CertifyID, where the authentication result query request further carries the CertifyID. After determining that the authentication result query request carries the authorization code, and before sending the face authentication result corresponding to the authorization code to the third-party server, the method further includes: determining whether the second correspondence exists between the CertifyID carried in the authentication result query request and the authorization code carried in the authentication result query request; and if yes, continuing to send the face authentication result corresponding to the authorization code carried in the authentication result query request to the third-party server; or otherwise, refusing to return the face authentication result.

In the first aspect, before receiving the face authentication request sent by the face verification APP in the terminal device, the method further includes: receiving an authentication authorization request sent by the third-party server, where the authentication authorization request carries user identity information and a session identifier SessionID of a current session; obtaining an authentication identifier CertifyID corresponding to the user identity information; storing a third correspondence between the CertifyID and the SessionID; and sending the CertifyID to the third-party server, so that the third-party server sends the CertifyID to the third-party APP, where the face authentication request sent by the face verification APP further carries the CertifyID and the SessionID that are reported by the third-party APP to the face verification APP. After receiving the face authentication request sent by the face verification APP in the terminal device, and before obtaining the face authentication result, the method further includes: determining whether the third correspondence exists between the CertifyID carried in the face authentication request and the SessionID carried in the face authentication request; and if yes, continuing to obtain the face authentication result; or otherwise, determining that face authentication fails.

In the first aspect, after generating the authorization code, the method further includes: storing a fourth correspondence between the generated authorization code and the SessionID obtained from the authentication authorization request. After determining that the authentication result query request carries the authorization code, and before sending the face authentication result corresponding to the authorization code to the third-party server, the method further includes: determining whether the authentication result query request sent by the third-party server carries the SessionID; if yes, determining whether the fourth correspondence exists between the SessionID carried in the authentication result query request and the authorization code carried in the authentication result query request; and if yes, continuing to send the face authentication result corresponding to the authorization code carried in the authentication result query request to the third-party server; or otherwise, refusing to return the face authentication result.

According to a second aspect, a face authentication method is provided. The method includes: receiving an authentication trigger request sent by a third-party APP in a terminal device; obtaining face information of a user; adding the face information to a face authentication request and sending the face authentication request to a verification server; and sending an authorization code to the third-party APP if the authorization code delivered by the verification server is received.

In the second aspect, the authentication trigger request sent by the third-party APP carries an authentication identifier CertifyID and a session identifier SessionID of a current session. Adding the face information to the face authentication request and sending the face authentication request to the verification server includes: adding the face information and the CertifyID and the SessionID that are obtained from the authentication trigger request to the face authentication request, and sending the face authentication request to the verification serve.

According to a third aspect, a face authentication method is provided. The method includes: receiving an authentication result query request sent by a third-party APP, where the authentication result query request carries an authorization code; sending the authentication result query request that carries the authorization code to a verification server; receiving a face authentication result sent by the verification server; and sending the face authentication result to the third-party APP.

In the third aspect, before receiving the authentication result query request sent by the third-party APP, the method further includes: receiving an authentication authorization request sent by the third-party APP, where the authentication authorization request carries user identity information and a session identifier SessionID of a current session; and sending the authentication authorization request that carries the user identity information and the SessionID to the verification server. Sending the authentication result query request that carries the authorization code to the verification server includes: sending the authentication result query request that carries the authorization code and the SessionID to the verification server.

According to a fourth aspect, a face authentication method is provided. The method includes: sending an authentication trigger request to a face verification APP in a terminal device, to trigger the face verification APP to obtain face information of a user; receiving an authorization code sent by the face verification APP; sending an authentication result query request that carries the authorization code to a third-party server, to trigger the third-party server to query a face authentication result; and receiving the face authentication result sent by the third-party server.

In the fourth aspect, before sending the authentication trigger request to the face verification APP in the terminal device, the method further includes: sending an authentication authorization request to the third-party server, where the authentication authorization request carries user identity information and a session identifier SessionID of a current session. Sending the authentication trigger request to the face verification APP in the terminal device includes: adding, to the authentication trigger request, the SessionID and an authentication identifier CertifyID sent by the third-party server, and sending the authentication trigger request to the face verification APP in the terminal device, where the authentication result query request further carries the CertifyID and/or the SessionID.

According to a fifth aspect, a face authentication apparatus is provided. The apparatus is disposed in a verification server. The apparatus includes: a face authentication request receiving module, configured to receive a face authentication request sent by a face verification APP in a terminal device, where the face authentication request carries face information; a face authentication execution module, configured to perform authentication on the face information to obtain a face authentication result; an authentication result processing module, configured to: generate an authorization code, and store a first correspondence between the authorization code and the face authentication result; an authorization code delivery module, configured to deliver the generated authorization code to the face verification APP, so that the face verification APP sends the authorization code to a third-party APP; and a result query processing module, configured to: receive an authentication result query request from a third-party server; determine whether the authentication result query request carries the authorization code; and if yes, send the face authentication result corresponding to the authorization code carried in the authentication result query request to the third-party server, so that the third-party server sends the face authentication result to the third-party APP.

According to a sixth aspect, a face authentication apparatus is provided. The apparatus is disposed in a terminal device, and is configured to perform processing of a face verification APP. The apparatus includes: a trigger request receiving module, configured to receive an authentication trigger request sent by a third-party APP in the terminal device; a face information processing module, configured to: obtain face information of a user, and add the face information to a face authentication request and send the face authentication request to a verification server; and an authorization code forwarding module, configured to send an authorization code to the third-party APP if the authorization code delivered by the verification server is received.

According to a seventh aspect, a face authentication apparatus is provided. The apparatus is disposed in a third-party server. The apparatus includes: a query request receiving module, configured to receive an authentication result query request sent by a third-party APP, where the authentication result query request carries an authorization code; a query request forwarding module, configured to send the authentication result query request that carries the authorization code to a verification server; and an authentication result acquisition module, configured to: receive a face authentication result sent by the verification server, and send the face authentication result to the third-party APP.

According to an eighth aspect, a face authentication apparatus is provided. The apparatus is disposed in a terminal device, and is configured to implement processing of a third-party APP. The apparatus includes: a trigger request sending module, configured to send an authentication trigger request to a face verification APP in the terminal device, to trigger the face verification APP to obtain face information of a user; an authorization code receiving module, configured to receive an authorization code sent by the face verification APP; a query request sending module, configured to send an authentication result query request that carries the authorization code to a third-party server, to trigger the third-party server to query a face authentication result; and an authentication result determining module, configured to receive the face authentication result sent by the third-party server.

According to a ninth aspect, a computing device is provided, including a memory and a processor. The memory stores executable code, and when the processor executes the executable code, the method according to any embodiment of this specification is implemented.

The face authentication methods and apparatuses provided in the embodiments of this specification have at least the following beneficial effects: 1. After performing authentication on the face information, the verification server does not directly deliver the face authentication result, such as a state value representing successful verification or a state value representing failed verification, to the face verification APP, but delivers the authorization code to the face verification APP. Correspondingly, the face verification APP also cannot send the face authentication result to the third-party APP. As such, even if an attack behavior occurs, and an attacker steals the authorization code, the attacker cannot obtain the face authentication result based on the authorization code, and the attacker cannot modify the face authentication result. Therefore, security of a face authentication service is greatly improved.

2. The face authentication result is provided by using the first correspondence. Specifically, considering that the CertifyID corresponds to the user identity information rather than the face information in authentication, in the embodiments of this specification, the CertifyID is not used as a credential for querying the face authentication result, but the authorization code that can represent the face information in one authentication process is used as the credential for querying the face authentication result. In other words, if the third-party APP and the third-party server can provide a correct authorization code to the verification server, the verification server provides the face authentication result based on the first correspondence that is between the authorization code and the face authentication result and that is pre-stored in the verification server.

3. The face authentication result is not directly sent to the third-party APP, but the authorization code is sent first, and the third-party APP cannot learn of the face authentication result based on the authorization code. Therefore, the third-party APP and the third-party server are forced to actively query the face authentication result from the verification server based on the obtained authorization code, thereby satisfying a protocol requirement, and further improving security of the face authentication service.

4. The third correspondence is used to resolve a possible problem of CertifyID leakage. Specifically, in the verification server, based on the third correspondence that is between the SessionID and the CertifyID and that is pre-stored in the verification server, it can be determined whether the CertifyID carried in the face authentication request is valid, and whether an attack behavior caused by CertifyID leakage occurs. If yes, the face authentication result is not provided. Therefore, security of the face authentication process can be further improved.

5. Validity of the third-party server and the third-party APP that query the face authentication result is verified by using the second correspondence. Specifically, the verification server can pre-store the second correspondence between the authorization code and the CertifyID. If the third-party server can provide the authorization code and the CertifyID that have the second correspondence, validity of the third-party APP and the third-party server can be determined, and the face authentication result is provided.

6. Validity of the third-party server and the third-party APP that query the face authentication result is verified by using the fourth correspondence. Specifically, the verification server can pre-store the fourth correspondence between the authorization code and the SessionID. If the third-party server can provide the authorization code and the SessionID that have the fourth correspondence, validity of the third-party APP and the third-party server can be determined, and the face authentication result is provided.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show some embodiments of this specification, and a person of ordinary skill in the art can still derive other drawings from these accompanying drawings without creative efforts.

FIG. 1 is a schematic diagram illustrating a system architecture to which one or more embodiments of this specification are applied;

FIG. 2 is a flowchart illustrating a face authentication method performed in a verification server, according to one or more embodiments of this specification;

FIG. 3 is a flowchart illustrating a face authentication method performed in a face verification APP, according to one or more embodiments of this specification;

FIG. 4 is a flowchart illustrating a face authentication method performed in a third-party server, according to one or more embodiments of this specification;

FIG. 5 is a flowchart illustrating a face authentication method performed in a third-party APP, according to one or more embodiments of this specification;

FIG. 6 is a flowchart illustrating a face authentication method completed through cooperation between parties, according to one or more embodiments of this specification;

FIG. 7 is a schematic structural diagram illustrating a face authentication apparatus disposed in a verification server, according to one or more embodiments of this specification;

FIG. 8 is a schematic structural diagram illustrating a face authentication apparatus disposed in a terminal device to perform processing of a face verification APP, according to one or more embodiments of this specification;

FIG. 9 is a schematic structural diagram illustrating a face authentication apparatus disposed in a third-party server, according to one or more embodiments of this specification; and

FIG. 10 is a schematic structural diagram illustrating a face authentication apparatus disposed in a terminal device to perform processing of a third-party APP, according to one or more embodiments of this specification.

### DESCRIPTION OF EMBODIMENTS

The solutions provided in this specification are described below with reference to the accompanying drawings.

First, it is worthwhile to note that, terms used in the embodiments of this specification are merely intended to describe specific embodiments, but are not intended to limit this specification. The terms “a”, “the”, and “this” in singular forms in the embodiments of this specification and the appended claims are also intended to include plural forms, unless otherwise stated in the context clearly.

It should be understood that the term “and/or” used in this specification merely describes an association relationship between associated objects, and represents that three relationships can exist. For example, “A and/or B” can represent the following three cases: Only A exists, both A and B exist, and only B exists. In addition, the character “/” in this specification usually indicates an “or” relationship between associated objects.

On a terminal device side, an application, which is referred to as a third-party APP, sends collected face information to a verification server through a face verification APP on the terminal device side when the application needs to use a face authentication service. The verification server verifies a face, and then the verification server sends a face authentication result to a third-party APP through the face verification APP. However, in the process in which the verification server delivers the face authentication result to the face verification APP and the face verification APP delivers the face authentication result to the third-party APP, the face authentication result may be changed due to an attack. For example, if the face authentication is initiated by an attacker by using a false face, although the face authentication result delivered by the verification server is “fail”, the attacker can modify the delivered face authentication result to change the face authentication result to “succeed”. As a result, security of a face authentication service is greatly reduced.

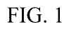

To facilitate understanding of the methods provided in this specification, a system architecture used in and applicable to this specification is first described. As shown in FIG. 1, the system architecture mainly includes four network nodes: a third-party APP, a face verification APP, a third-party server, and a verification server.

The third-party APP and the face verification APP are installed and run in a terminal device. The terminal device can include but is not limited to a smart mobile terminal, a smart home device, a network device, a wearable device, a smart medical device, a personal computer (PC), etc. The smart mobile device can include a mobile phone, a tablet computer, a notebook computer, a personal digital assistant (PDA), an Internet vehicle, etc. The smart home device can include a smart appliance, such as a smart television, a smart air conditioner, a smart water heater, a smart refrigerator, or a smart air purifier. The smart home device can further include a smart door lock, a smart socket, a smart light, a smart camera, etc. The network device can include a switch, a wireless AP, a server, etc. The wearable device can include a smart watch, smart glasses, a smart band, a virtual reality device, an augmented reality device, a hybrid reality device (that is, a device that can support virtual reality and augmented reality), etc. The smart medical device can include a smart thermometer, a smart blood pressure monitor, a smart glucose meter, etc.

The third-party server can be a single server, or can be a server group including a plurality of servers, and is responsible for providing network services, such as security authentication and network service level management, for the third-party APP.

The verification server can be a single server, or can be a server group including a plurality of servers, and is responsible for providing network services, such as face comparison, for the face verification APP.

It should be understood that quantities of third-party APPs, face verification APPs, third-party servers, and verification servers in FIG. 1 are merely examples. Any quantity of third-party APPs, face verification APPs, third-party servers, and verification servers can be selected and arranged based on an actual implementation requirement.

It can be seen that the methods in the embodiments of this application relate to processing of the third-party APP, processing of the face verification APP, processing of the third-party server, and processing of the verification server. The following separately describes processing of the parties in a face authentication process by using different embodiments.

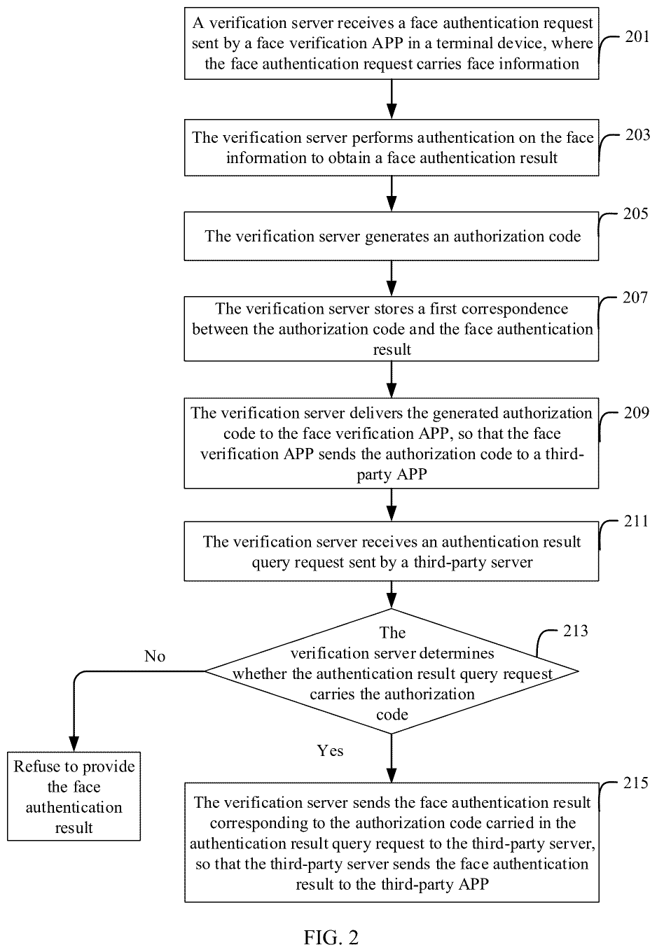

The following first describes processing in the verification server. FIG. 2 is a flowchart illustrating a face authentication method performed in a verification server, according to one or more embodiments of this specification. The method is performed by a face authentication apparatus. The apparatus is located in the verification server. It can be understood that the method can alternatively be performed by any apparatus, device, platform, or device cluster having computing and processing capabilities. Referring to FIG. 2, the method includes step 201 to step 215.

Step 201: The verification server receives a face authentication request sent by a face verification APP in a terminal device, where the face authentication request carries face information.

Step 203: The verification server performs authentication on the face information to obtain a face authentication result. Step 205: The verification server generates an authorization code. Step 207: The verification server stores a first correspondence between the authorization code and the face authentication result. Step 209: The verification server delivers the generated authorization code to the face verification APP, so that the face verification APP sends the authorization code to a third-party APP. Step 211: The verification server receives an authentication result query request sent by a third-party server. Step 213: The verification server determines whether the authentication result query request carries the authorization code, and if yes, performs step 215; or otherwise, refuses to provide the face authentication result, and ends the current procedure.

Step 215: The verification server sends the face authentication result corresponding to the authorization code carried in the authentication result query request to the third-party server, so that the third-party server sends the face authentication result to the third-party APP.

The procedure shown in FIG. 2 describes processing in the verification server. Corresponding to the processing of the verification server shown in FIG. 2, the face verification APP, the third-party server, and the third-party APP also need to cooperate to complete corresponding processing.

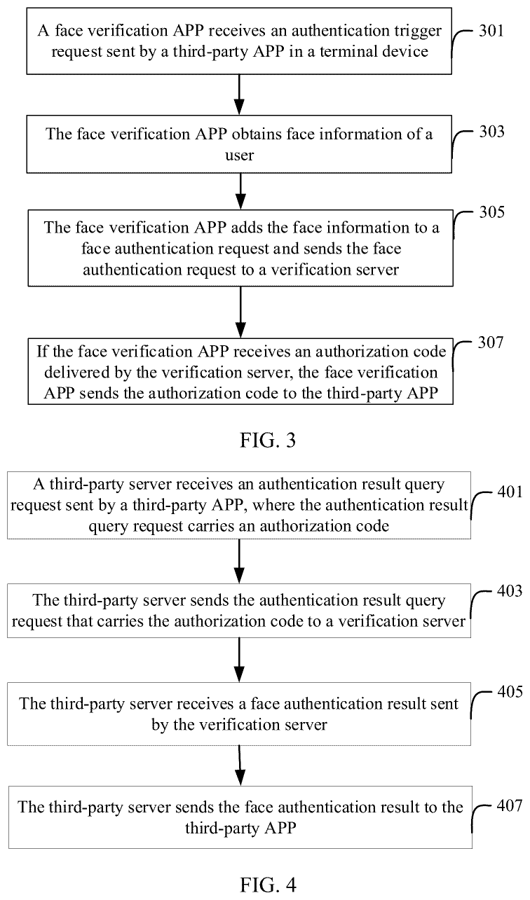

The following describes corresponding processing performed in the face verification APP corresponding to the processing in the verification server shown in FIG. 2. FIG. 3 is a flowchart illustrating a face authentication method performed in a face verification APP, according to one or more embodiments of this specification. The method is performed by a face authentication apparatus. The apparatus is located in a terminal device. It can be understood that the method can alternatively be performed by any apparatus, device, platform, or device cluster having computing and processing capabilities. Referring to FIG. 3, the method includes step 301 to step 307.

Step 301: The face verification APP receives an authentication trigger request sent by a third-party APP in the terminal device.

Step 303: The face verification APP obtains face information of a user.

Step 305: The face verification APP adds the face information to a face authentication request and sends the face authentication request to a verification server.

Step 307: If the face verification APP receives an authorization code delivered by the verification server, the face verification APP sends the authorization code to the third-party APP.

The following describes corresponding processing performed in the third-party server corresponding to the processing of the verification server shown in FIG. 2. FIG. 4 is a flowchart illustrating a face authentication method performed in a third-party server, according to one or more embodiments of this specification. The method is performed by a face authentication apparatus. The apparatus is located in the third-party server. It can be understood that the method can alternatively be performed by any apparatus, device, platform, or device cluster having computing and processing capabilities. Referring to FIG. 4, the method includes step 401 to step 407.

Step 401: The third-party server receives an authentication result query request sent by a third-party APP, where the authentication result query request carries an authorization code.

Step 403: The third-party server sends the authentication result query request that carries the authorization code to a verification server.

Step 405: The third-party server receives a face authentication result sent by the verification server.

Step 407: The third-party server sends the face authentication result to the third-party APP.

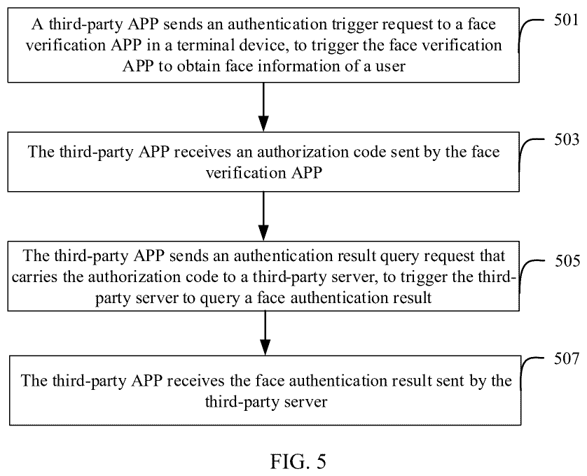

The following describes corresponding processing performed in the third-party APP corresponding to the processing of the verification server shown in FIG. 2. FIG. 5 is a flowchart illustrating a face authentication method performed in a third-party APP, according to one or more embodiments of this specification; The method is performed by a face authentication apparatus. The apparatus is located in a terminal device. It can be understood that the method can alternatively be performed by any apparatus, device, platform, or device cluster having computing and processing capabilities. Referring to FIG. 5, the method includes step 501 to step 507.

Step 501: The third-party APP sends an authentication trigger request to a face verification APP in the terminal device, to trigger the face verification APP to obtain face information of a user.

Step 503: The third-party APP receives an authorization code sent by the face verification APP.

Step 505: The third-party APP sends an authentication result query request that carries the authorization code to a third-party server, to trigger the third-party server to query a face authentication result.

Step 507: The third-party APP receives the face authentication result sent by the third-party server.

As described above, the verification server directly delivers the face authentication result, such as a state value representing successful verification or a state value representing failed verification, to the face verification APP. Correspondingly, the face verification APP also directly sends the face authentication result to the third-party APP. When an attack behavior against the face authentication result occurs, the face authentication result received by the face verification APP or the third-party APP is changed. For example, if the face authentication is initiated by an attacker by using a false face, although the face authentication result delivered by the verification server is “fail”, the attacker can modify the delivered face authentication result to change the face authentication result to “succeed”. As a result, security of a face authentication service is greatly reduced. On the contrary, referring to the above-mentioned procedures shown in FIG. 2 to FIG. 5, in the embodiments of this specification, after performing authentication on the face information, the verification server does not directly deliver the face authentication result, such as a state value representing successful verification or a state value representing failed verification, to the face verification APP, but delivers the authorization code to the face verification APP. Correspondingly, the face verification APP also cannot send the face authentication result to the third-party APP. As such, even if an attack behavior occurs, and an attacker steals the authorization code, the attacker cannot obtain the face authentication result based on the authorization code, and the attacker cannot modify the face authentication result. Therefore, security of a face authentication service is greatly improved. Referring to FIG. 2 to FIG. 5, subsequently, the third-party APP and the third-party server can obtain the face authentication result if the third-party APP and the third-party server can provide a correct authorization code to the verification server.

To improve security, in the face authentication service, after the third-party APP receives the face verification result forwarded by the face verification APP, the third-party APP and the third-party server are also required to actively query the face verification result from the verification server. However, in a related technology, because the third-party APP has obtained, from the face verification result forwarded by the face verification APP, a result indicating whether the face verification succeeds, many third-party APPs and third-party servers do not actively query the face verification result from the verification server based on a protocol requirement, which violates the protocol requirement and reducing security of the face authentication service. On the contrary, referring to the procedures shown in FIG. 2 to FIG. 5, in the embodiments of this specification, the face authentication result is not directly sent to the third-party APP, but the authorization code is sent first, and the third-party APP cannot learn of the face authentication result based on the authorization code. Therefore, the third-party APP and the third-party server are forced to actively query the face authentication result from the verification server based on the obtained authorization code, thereby satisfying the protocol requirement, and further improving security of the face authentication service. In the above-mentioned embodiments of this specification, the authorization code is used to prevent an attacker from modifying the face authentication result.

In the embodiments of this specification, the following problems in a face authentication process are further considered: 1. How to verify validity of the third-party APP and the third-party server by using the authorization code when the third-party APP and the third-party server actively query the face verification result from the verification server.

2. How to avoid a face authentication security problem caused by leakage of an authentication identifier (CertifyID).

For the above-mentioned problem in the first point, validity of the third-party APP and the third-party server can be verified in the following two methods: Method A: Validity of the third-party APP and the third-party server is verified by using a correspondence, denoted as a second correspondence, between the authorization code and a CertifyID.

Method B. Validity of the third-party APP and the third-party server is verified by using a correspondence, denoted as a fourth correspondence, between the authorization code and a session identifier (SessionID).

The following describes the above-mentioned method A.

In a face authentication service, identity information of each user, such as a name of the user, uniquely corresponds to one CertifyID, that is, one CertifyID represents one user. In a session, because face information of a user needs to be authenticated, a CertifyID corresponding to identity information of the user is transmitted between the verification server, the third-party server, the face verification APP, and the third-party APP. With this feature, in one or more embodiments of this specification, the correspondence, that is, the second correspondence, between the authorization code and the CertifyID can be stored in the verification server, to verify validity of the third-party APP and the third-party server by using the second correspondence.

In the method A, when the third-party APP needs to use a face authentication function, before the face verification APP sends the face information, the third-party APP sends an authentication authorization request that carries user identity information to the third-party server, and the third-party server sends the authentication authorization request that carries the user identity information to the verification server, to obtain a CertifyID by using the user identity information. To be specific, the verification server receives the authentication authorization request sent by the third-party server, obtains the authentication identifier CertifyID based on the user identity information carried in the authentication authorization request, and sends the CertifyID to the third-party server; then the third-party server sends the CertifyID to the third-party APP; and further, the verification server generates the authorization code, and the verification server stores the second correspondence between the generated authorization code and the obtained CertifyID. Afterwards, when the face authentication result needs to be queried, the third-party APP sends the authentication result query request that carries the CertifyID and the authorization code to the third-party server, and then the third-party server sends the authentication result query request that carries the CertifyID and the authorization code to the verification server. As such, in step 213, after the verification server determines that the authentication result query request carries the authorization code, and before the verification server sends the face authentication result corresponding to the authorization code to the third-party server, the method further includes the following: The verification server determines whether the second correspondence stored in the verification server exists between the CertifyID carried in the authentication result query request and the authorization code carried in the authentication result query request, that is, whether a correspondence between the CertifyID carried in the authentication result query request and the authorization code carried in the authentication result query request can be found in the second correspondence stored in the verification server; and if yes, the verification server determines that the third-party server and the third-party APP are valid, and continues to send the face authentication result corresponding to the authorization code carried in the authentication result query request to the third-party server; or otherwise, the verification server determines that the third-party server and the third-party APP are invalid, and refuses to return the face authentication result.

The following first describes a method for resolving the above-mentioned problem in the second point. Based on the solution, the method B for resolving the above-mentioned problem in the first point can be further implemented.

As described above, in the face authentication service, one CertifyID represents identity information of one user. As such, a same CertifyID is used in different times of face authentication of a same user. In different face authentication, if an attack behavior occurs, and an attacker steals identity information of a user, the attacker can obtain a CertifyID corresponding to the identity information of the user. Therefore, a certain risk still exists, causing reduction in security of a face authentication process. This risk can be further avoided by using a SessionID that identifies a session. Because the SessionID represents not only user identity information in one time of face authentication but also face information in current face authentication, the above-mentioned problem in the second point can be resolved.

In this case, when the third-party APP needs to use a face authentication function, the third-party APP obtains a SessionID of a current session. Before the face verification APP sends the face information, the third-party APP sends an authentication authorization request that carries user identity information and the SessionID to the third-party server, and the third-party server sends the authentication authorization request that carries the user identity information and the SessionID to the verification server. Therefore, a CertifyID is obtained by using the user identity information, and the SessionID of the current session is reported to the verification server. To be specific, the verification server receives the authentication authorization request sent by the third-party server, where the authentication authorization request carries the user identity information and the SessionID of the current session, obtains the CertifyID corresponding to the user identity information, stores a third correspondence between the CertifyID and the SessionID, and sends the CertifyID and the SessionID to the third-party server, so that the third-party server sends the CertifyID and the SessionID to the third-party APP. Then, the third-party APP adds the obtained CertifyID and SessionID to the authentication trigger request and sends the authentication trigger request to the face verification APP in the terminal device. The APP adds the obtained face information and the CertifyID and the SessionID that are obtained from the authentication trigger request to the face authentication request and sends the face authentication request to the verification server. After receiving the face authentication request sent by the face verification APP and before performing authentication on a face to obtain the face authentication result, the method further includes the following: The verification server determines whether the third correspondence exists between the CertifyID carried in the face authentication request and the SessionID carried in the face authentication request, that is, whether a correspondence between the CertifyID carried in the face authentication request and the SessionID carried in the face authentication request can be found in the third correspondence stored in the verification server; and if yes, the verification server determines that the CertifyID is not stolen, and continues to perform authentication on the face to obtain the face authentication result; or otherwise, the verification server determines that face authentication fails. It can be seen that the processing process resolves the above-mentioned problem 2. Further, the verification server generates the authorization code, and the verification server saves a fourth correspondence between the generated authorization code and the obtained SessionID. Afterwards, when the face authentication result needs to be queried, the third-party APP sends the authentication result query request that carries the SessionID and the authorization code to the third-party server, and then the third-party server sends the authentication result query request that carries the SessionID and the authorization code to the verification server. As such, in step 213, after the verification server determines that the authentication result query request carries the authorization code, and before the verification server sends the face authentication result corresponding to the authorization code to the third-party server, the method further includes the following: The verification server determines whether the fourth correspondence stored in the verification server exists between the SessionID carried in the authentication result query request and the authorization code carried in the authentication result query request, that is, whether a correspondence between the SessionID carried in the authentication result query request and the authorization code carried in the authentication result query request can be found in the fourth correspondence stored in the verification server; and if yes, the verification server determines that the third-party server and the third-party APP are valid, and continues to send the face authentication result corresponding to the authorization code carried in the authentication result query request to the third-party server; or otherwise, the verification server determines that the third-party server and the third-party APP are invalid, and refuses to return the face authentication result. It can be seen that the method B for the problem in the first point is implemented.

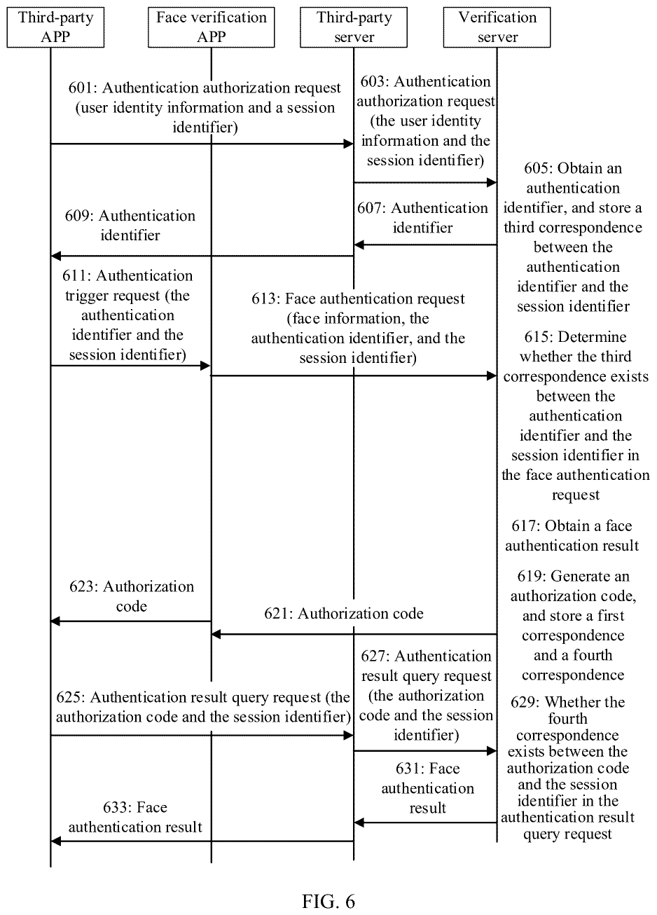

FIG. 6 is a flowchart illustrating a face authentication method completed through cooperation between parties, according to one or more embodiments of this specification. Referring to FIG. 6, the method includes step 601 to step 633.

Step 601: A third-party APP obtains a SessionID, and sends an authentication authorization request that carries the sessionID and user identity information to a third-party server.

Step 603: The third-party server sends the authentication authorization request that carries the sessionID and the user identity information to a verification server.

Step 605: The verification server obtains a CertifyID corresponding to the user identity information carried in the authentication authorization request, and stores a correspondence, denoted as a third correspondence, between the obtained CertifyID and the sessionID carried in the authentication authorization request.

Step 607: The verification server sends the obtained CertifyID to the third-party server.

Step 609: The third-party server sends the received CertifyID to a third-party APP.

In step 609, to improve security, the third-party server can send a signed CertifyID to the third-party APP.

Step 611: The third-party APP adds the SessionID and the received CertifyID to an authentication trigger request and sends the authentication trigger request to a face verification APP in a terminal device.

Step 613: The face verification APP obtains face information of a user, adds the face information and the CertifyID and the SessionID that are obtained from the authentication trigger request to a face authentication request, and sends the face authentication request to the verification server.

Step 615: The verification server determines whether the third correspondence exists between the CertifyID carried in the face authentication request and the SessionID carried in the face authentication request, that is, whether a correspondence between the CertifyID carried in the face authentication request and the SessionID carried in the face authentication request can be found in the third correspondence stored in the verification server; and if yes, the verification server determines that the CertifyID is not stolen, and performs step 617; or otherwise, the verification server determines that face authentication fails, and ends the current procedure.

Step 617: The verification server performs authentication on the face information to obtain a face authentication result.

Step 619: The verification server generates an authorization code, and stores a correspondence, denoted as a first correspondence, between the authorization code and the face authentication result; and the verification server stores a correspondence, denoted as a fourth correspondence, between the authorization code and the SessionID.

In step 619, instead of storing the fourth correspondence, the verification server can store a correspondence, denoted as a second correspondence, between the authorization code and the CertifyID.

Step 621: The verification server sends the authorization code (Authcode) to the face verification APP.

Step 623: The face verification APP sends the authorization code to the third-party APP.

Step 625: The third-party APP adds the authorization code and the SessionID to an authentication result query request and sends the authentication result query request to the third-party server.

Step 627: The third-party server sends the authentication result query request that carries the authorization code and the SessionID to the verification server.

Step 629: After determining that the authentication result query request carries the authorization code, the verification server determines whether the fourth correspondence stored in the verification server exists between the SessionID carried in the authentication result query request and the authorization code carried in the authentication result query request; and if yes, performs step 631; or otherwise, refuses to return the face authentication result and ends the current procedure.

It is worthwhile to note that, from step 625 to step 627, instead of carrying the SessionID, the authentication result query request can carry the CertifyID. As such, in step 629, the verification server determines whether the second correspondence stored in the verification server exists between the CertifyID carried in the authentication result query request and the authorization code carried in the authentication result query request; and if yes, performs step 631; or otherwise, refuses to return the face authentication result and ends the current procedure.

Step 631: The verification server obtains, based on the first correspondence, the face authentication result corresponding to the authorization code carried in the authentication result query request, and sends the face authentication result to the third-party server.

Step 633: The third-party server sends the received face authentication result to the third-party APP.

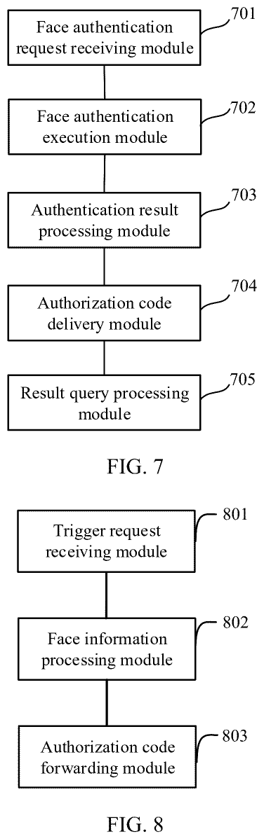

One or more embodiments of this specification further provide a face authentication apparatus. The apparatus is disposed in a verification server. Referring to FIG. 7, the apparatus includes: a face authentication request receiving module 701, configured to receive a face authentication request sent by a face verification APP in a terminal device, where the face authentication request carries face information; a face authentication execution module 702, configured to perform authentication on the face information to obtain a face authentication result; an authentication result processing module 703, configured to: generate an authorization code, and store a first correspondence between the authorization code and the face authentication result; an authorization code delivery module 704, configured to deliver the generated authorization code to the face verification APP, so that the face verification APP sends the authorization code to a third-party APP; and a result query processing module 705, configured to: receive an authentication result query request from a third-party server; determine whether the authentication result query request carries the authorization code; and if yes, send the face authentication result corresponding to the authorization code carried in the authentication result query request to the third-party server, so that the third-party server sends the face authentication result to the third-party APP.

In an embodiment of this specification, the face authentication apparatus disposed in the verification server shown in FIG. 7 further includes a first authorization module (not shown in FIG. 7). The first authorization module is configured to: receive an authentication authorization request sent by the third-party server; obtain an authentication identifier CertifyID based on user identity information carried in the authentication authorization request; and send the CertifyID to the third-party server. Correspondingly, the authentication result processing module 703 is further configured to store a second correspondence between the generated authorization code and the obtained CertifyID after generating the authorization code, where the authentication result query request further carries the CertifyID. Correspondingly, the result query processing module 705 is configured to: after determining that the authentication result query request carries the authorization code and before sending the face authentication result corresponding to the authorization code to the third-party server, determine whether the second correspondence exists between the CertifyID carried in the authentication result query request and the authorization code carried in the authentication result query request; and if yes, continue to send the face authentication result corresponding to the authorization code carried in the authentication result query request to the third-party server; or otherwise, refuse to return the face authentication result.

In an embodiment of this specification, the face authentication apparatus disposed in the verification server shown in FIG. 7 further includes a second authorization module (not shown in FIG. 7). The second authorization module is configured to: receive an authentication authorization request sent by the third-party server, where the authentication authorization request carries user identity information and a session identifier SessionID of a current session; obtain an authentication identifier CertifyID corresponding to the user identity information; store a third correspondence between the CertifyID and the SessionID; and send the CertifyID to the third-party server, so that the third-party server sends the CertifyID to the third-party APP. Correspondingly, the face authentication request received by the face authentication request receiving module 701 further carries the CertifyID and the SessionID that are reported by the third-party APP to the face verification APP. Correspondingly, the result query processing module 705 is configured to: after receiving the face authentication request sent by the face verification APP in the terminal device and before obtaining the face authentication result, determine whether the third correspondence exists between the CertifyID carried in the face authentication request and the SessionID carried in the face authentication request; and if yes, continue to obtain the face authentication result; or otherwise, determine that face authentication fails.

In an embodiment of this specification, when the face authentication apparatus disposed in the verification server shown in FIG. 7 further includes the second authorization module, the authentication result processing module 703 is further configured to store a fourth correspondence between the generated authorization code and the SessionID obtained from the authentication authorization request after generating the authorization code. Correspondingly, the result query processing module 705 is configured to: after determining that the authentication result query request carries the authorization code and before sending the face authentication result corresponding to the authorization code to the third-party server, determine whether the authentication result query request sent by the third-party server carries the SessionID; if yes, determine whether the fourth correspondence exists between the SessionID carried in the authentication result query request and the authorization code carried in the authentication result query request; and if yes, continue to send the face authentication result corresponding to the authorization code carried in the authentication result query request to the third-party server; or otherwise, refuse to return the face authentication result.

One or more embodiments of this specification further provide a face authentication apparatus. The apparatus is disposed in a terminal device, and is configured to perform processing of a face verification APP. Referring to FIG. 8, the apparatus includes: a trigger request receiving module 801, configured to receive an authentication trigger request sent by a third-party APP in the terminal device; a face information processing module 802, configured to: obtain face information of a user, and add the face information to a face authentication request and send the face authentication request to a verification server; and an authorization code forwarding module 803, configured to send an authorization code to the third-party APP if the authorization code delivered by the verification server is received.

In an embodiment of this specification, in the face authentication apparatus disposed in the terminal device shown in FIG. 8, the authentication trigger request received by the trigger request receiving module 801 carries an authentication identifier CertifyID and a session identifier SessionID of a current session. Correspondingly, the face information processing module 802 is configured to: add the face information and the CertifyID and the SessionID that are obtained from the authentication trigger request to the face authentication request, and send the face authentication request to the verification server.

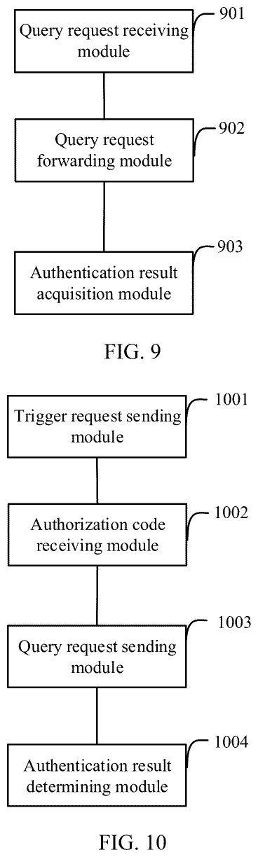

One or more embodiments of this specification further provide a face authentication apparatus. The apparatus is disposed in a third-party server. Referring to FIG. 9, the apparatus includes: a query request receiving module 901, configured to receive an authentication result query request sent by a third-party APP, where the authentication result query request carries an authorization code; a query request forwarding module 902, configured to send the authentication result query request that carries the authorization code to a verification server; and an authentication result acquisition module 903, configured to: receive a face authentication result sent by the verification server, and send the face authentication result to the third-party APP.

In an embodiment of this specification, the face authentication apparatus disposed in the third-party server shown in FIG. 9 further includes an authorization request forwarding module (not shown in the figure). The authorization request forwarding module is configured to: receive an authentication authorization request sent by the third-party APP, where the authentication authorization request carries user identity information and a session identifier SessionID of a current session; and send the authentication authorization request that carries the user identity information and the SessionID to the verification server. The query request forwarding module 902 is configured to send the authentication result query request that carries the authorization code and the SessionID to the verification server.

One or more embodiments of this specification further provide a face authentication apparatus. The apparatus is disposed in a terminal device, and is configured to implement a function of a third-party APP. Referring to FIG. 10, the apparatus includes: a trigger request sending module 1001, configured to send an authentication trigger request to a face verification APP in the terminal device, to trigger the face verification APP to obtain face information of a user; an authorization code receiving module 1002, configured to receive an authorization code sent by the face verification APP; a query request sending module 1003, configured to send an authentication result query request that carries the authorization code to a third-party server, to trigger the third-party server to query a face authentication result; and an authentication result determining module 1004, configured to receive the face authentication result sent by the third-party server. In an embodiment of this specification, the face authentication apparatus disposed in the terminal device shown in FIG. 10 further includes an authorization request sending module (not shown in the figure), configured to send an authentication authorization request to the third-party server, where the authentication authorization request carries user identity information and a session identifier SessionID of a current session. The trigger request sending module 1001 is configured to: add, to the authentication trigger request, the SessionID and an authentication identifier CertifyID sent by the third-party server, and send the authentication trigger request to the face verification APP in the terminal device, where the authentication result query request further carries the CertifyID and/or the SessionID.

One or more embodiments of this specification provide a computer-readable storage medium. The computer-readable storage medium stores a computer program, and when the computer program is executed in a computer, the computer is enabled to perform the method in any embodiment of this specification.

One or more embodiments of this specification provide a computing device, including a memory and a processor. The memory stores executable code, and when the processor executes the executable code, the method in any embodiment of this specification is implemented.

It can be understood that the structure shown in the embodiments of this specification does not constitute a specific limitation on the apparatus in the embodiments of this specification. In some other embodiments of this specification, the above-mentioned apparatus can include more or fewer components than those shown in the figure, or combine some components, or split some components, or have different component arrangements. The components shown in the figure can be implemented by hardware, software, or a combination of software and hardware.

The embodiments of this specification are described in a progressive way. For same or similar parts in the embodiments, references can be made to each other. Each embodiment focuses on a difference from another embodiment. Particularly, the apparatus embodiments are basically similar to the method embodiments, and therefore are described briefly. For related parts, references can be made to some descriptions in the method embodiments.

The above-mentioned specific implementations further describe the objectives, technical solutions, and beneficial effects of this application in detail. It should be understood that the above-mentioned descriptions are merely specific implementations of this application, and are not intended to limit the protection scope of this application. Any modification, equivalent replacement, improvement, etc. made on the basis of the technical solutions of this application shall fall within the protection scope of this application.

1. A face authentication method, comprising:
receiving a face authentication request sent by a face verification application APP in a terminal device, wherein the face authentication request carries face information;
performing authentication on the face information to obtain a face authentication result;
generating an authorization code;
storing a first correspondence between the authorization code and the face authentication result;
delivering the generated authorization code to the face verification APP, so that the face verification APP sends the authorization code to a third-party APP;
receiving an authentication result query request sent by a third-party server; and
determining whether the authentication result query request carries the authorization code;
and if it is determined that the authentication result query request carries the authorization code, sending the face authentication result corresponding to the authorization code carried in the authentication result query request to the third-party server, so that the third-party server sends the face authentication result to the third-party APP.

2. The method according to claim 1, wherein before receiving the face authentication request sent by the face verification APP in the terminal device, the method further comprises: receiving an authentication authorization request sent by the third-party server; obtaining an authentication identifier CertifyID based on user identity information carried in the authentication authorization request; and sending the CertifyID to the third-party server;
after generating the authorization code, the method further comprises: storing a second correspondence between the generated authorization code and the obtained CertifyID, wherein
the authentication result query request further carries the CertifyID; and
after determining that the authentication result query request carries the authorization code, and before sending the face authentication result corresponding to the authorization code to the third-party server, the method further comprises: determining whether the second correspondence exists between the CertifyID carried in the authentication result query request and the authorization code carried in the authentication result query request; and if the second correspondence exists, continuing to send the face authentication result corresponding to the authorization code carried in the authentication result query request to the third-party server; or if the second correspondence does not exist, refusing to return the face authentication result.

3. The method according to claim 1, wherein before receiving the face authentication request sent by the face verification APP in the terminal device, the method further comprises: receiving an authentication authorization request sent by the third-party server, wherein the authentication authorization request carries user identity information and a session identifier SessionID of a current session; obtaining an authentication identifier CertifyID corresponding to the user identity information; storing a third correspondence between the CertifyID and the SessionID; and sending the CertifyID to the third-party server, so that the third-party server sends the CertifyID to the third-party APP, wherein
the face authentication request sent by the face verification APP further carries the CertifyID and the SessionID that are reported by the third-party APP to the face verification APP; and
after receiving the face authentication request sent by the face verification APP in the terminal device, and before obtaining the face authentication result, the method further comprises: determining whether the third correspondence exists between the CertifyID carried in the face authentication request and the SessionID carried in the face authentication request;
and if the third correspondence exists, continuing to obtain the face authentication result; or if the third correspondence does not exist, determining that the face authentication fails.

4. The method according to claim 3, wherein after generating the authorization code, the method further comprises: storing a fourth correspondence between the generated authorization code and the SessionID obtained from the authentication authorization request; and
after determining that the authentication result query request carries the authorization code, and before sending the face authentication result corresponding to the authorization code to the third-party server, the method further comprises: determining whether the authentication result query request sent by the third-party server carries the SessionID; if the authentication result query request carries the SessionID, determining whether the fourth correspondence exists between the SessionID carried in the authentication result query request and the authorization code carried in the authentication result query request; and if the fourth correspondence exists, continuing to send the face authentication result corresponding to the authorization code carried in the authentication result query request to the third-party server; or if the fourth correspondence does not exist, refusing to return the face authentication result.

5-14. (canceled)

15. A computing device, comprising a memory and a processor, wherein the memory stores executable code, and when the processor executes the executable code, the computing device is caused to:
receive a face authentication request sent by a face verification application APP in a terminal device, wherein the face authentication request carries face information;
perform authentication on the face information to obtain a face authentication result;
generate an authorization code;
store a first correspondence between the authorization code and the face authentication result;
deliver the generated authorization code to the face verification APP, so that the face verification APP sends the authorization code to a third-party APP;
receive an authentication result query request sent by a third-party server; and
determine whether the authentication result query request carries the authorization code; and if it is determined that the authentication result query request carries the authorization code, sending the face authentication result corresponding to the authorization code carried in the authentication result query request to the third-party server, so that the third-party server sends the face authentication result to the third-party APP.

16. The computing device according to claim 15, wherein before being caused to receive the face authentication request sent by the face verification APP in the terminal device, the computing device is further caused to: receive an authentication authorization request sent by the third-party server; obtain an authentication identifier CertifyID based on user identity information carried in the authentication authorization request; and send the CertifyID to the third-party server;
after being caused to generate the authorization code, the computing device is further caused to: store a second correspondence between the generated authorization code and the obtained CertifyID, wherein
the authentication result query request further carries the CertifyID, and
after being caused to determine that the authentication result query request carries the authorization code, and before being caused to send the face authentication result corresponding to the authorization code to the third-party server, the computing device is further caused to: determine whether the second correspondence exists between the CertifyID carried in the authentication result query request and the authorization code carried in the authentication result query request; and if the second correspondence exists, continue to send the face authentication result corresponding to the authorization code carried in the authentication result query request to the third-party server; or if the second correspondence does not exist, refuse to return the face authentication result.

17. The computing device according to claim 15, wherein before being caused to receive the face authentication request sent by the face verification APP in the terminal device, the computing device is further caused to: receive an authentication authorization request sent by the third-party server, wherein the authentication authorization request carries user identity information and a session identifier SessionID of a current session; obtain an authentication identifier CertifyID corresponding to the user identity information; store a third correspondence between the CertifyID and the SessionID; and send the CertifyID to the third-party server, so that the third-party server sends the CertifyID to the third-party APP, wherein
the face authentication request sent by a face verification APP further carries the CertifyID and the SessionID that are reported by the third-party APP to the face verification APP; and
after being caused to receive the face authentication request sent by the face verification APP in the terminal device, and before being caused to obtain the face authentication result, the computing device is further caused to: determine whether the third correspondence exists between the CertifyID carried in the face authentication request and the SessionID carried in the face authentication request; and if the third correspondence exists, continue to obtain the face authentication result; or if the third correspondence does not exist, determine that the face authentication fails.

18. The computing device according to claim 17, wherein after being caused to generate the authorization code, the computing device is further caused to: store a fourth correspondence between the generated authorization code and the SessionID obtained from the authentication authorization request; and
after being caused to determine that the authentication result query request carries the authorization code, and before being caused to send the face authentication result corresponding to the authorization code to the third-party server, the computing device is further caused to: determine whether the authentication result query request sent by the third-party server carries the SessionID; if the authentication result query request carries the SessionID, determine whether the fourth correspondence exists between the SessionID carried in the authentication result query request and the authorization code carried in the authentication result query request; and if the fourth correspondence exists, continue to send the face authentication result corresponding to the authorization code carried in the authentication result query request to the third-party server; or if the fourth correspondence does not exist, refuse to return the face authentication result.

19. A non-transitory computer-readable storage medium, wherein the non-transitory computer-readable storage medium stores a computer program, which when executed by a processor causes the processor to:
receive a face authentication request sent by a face verification application APP in a terminal device, wherein the face authentication request carries face information;
perform authentication on the face information to obtain a face authentication result;
generate an authorization code;
store a first correspondence between the authorization code and the face authentication result;
deliver the generated authorization code to the face verification APP, so that the face verification APP sends the authorization code to a third-party APP;
receive an authentication result query request sent by a third-party server; and
determine whether the authentication result query request carries the authorization code; and if it is determined that the authentication result query request carries the authorization code, sending the face authentication result corresponding to the authorization code carried in the authentication result query request to the third-party server, so that the third-party server sends the face authentication result to the third-party APP.

20. The non-transitory computer-readable storage medium according to claim 19, wherein before being caused to receive the face authentication request sent by the face verification APP in the terminal device, the processor is further caused to: receive an authentication authorization request sent by the third-party server; obtain an authentication identifier CertifyID based on user identity information carried in the authentication authorization request; and send the CertifyID to the third-party server;
after being caused to generate the authorization code, the processor is further caused to:
store a second correspondence between the generated authorization code and the obtained CertifyID, wherein
the authentication result query request further carries the CertifyID; and
after being caused to determine that the authentication result query request carries the authorization code, and before being caused to send the face authentication result corresponding to the authorization code to the third-party server, the processor is further caused to: determine whether the second correspondence exists between the CertifyID carried in the authentication result query request and the authorization code carried in the authentication result query request; and if the second correspondence exists, continue to send the face authentication result corresponding to the authorization code carried in the authentication result query request to the third-party server; or if the second correspondence does not exist, refuse to return the face authentication result.

21. The non-transitory computer-readable storage medium according to claim 19, wherein before being caused to receive the face authentication request sent by the face verification APP in the terminal device, the processor is further caused to: receive an authentication authorization request sent by the third-party server, wherein the authentication authorization request carries user identity information and a session identifier SessionID of a current session; obtain an authentication identifier CertifyID corresponding to the user identity information; store a third correspondence between the CertifyID and the SessionID, and send the CertifyID to the third-party server, so that the third-party server sends the CertifyID to the third-party APP, wherein
the face authentication request sent by the face verification APP further carries the CertifyID and the SessionID that are reported by the third-party APP to the face verification APP; and
after being caused to receive the face authentication request sent by the face verification APP in the terminal device, and before being caused to obtain the face authentication result, the processor is further caused to: determine whether the third correspondence exists between the CertifyID carried in the face authentication request and the SessionID carried in the face authentication request; and if the third correspondence exists, continue to obtain the face authentication result; or if the third correspondence does not exist, determine that the face authentication fails.

22. The non-transitory computer-readable storage medium according to claim 21, wherein after being caused to generate the authorization code, the processor is further caused to: store a fourth correspondence between the generated authorization code and the SessionID obtained from the authentication authorization request; and
after being caused to determine that the authentication result query request carries the authorization code, and before being caused to send the face authentication result corresponding to the authorization code to the third-party server, the processor is further caused to: determine whether the authentication result query request sent by the third-party server carries the SessionID; if the authentication result query request carries the SessionID, determine whether the fourth correspondence exists between the SessionID carried in the authentication result query request and the authorization code carried in the authentication result query request; and if the fourth correspondence exists, continue to send the face authentication result corresponding to the authorization code carried in the authentication result query request to the third-party server; or if the fourth correspondence does not exist, refuse to return the face authentication result.
